(19) United States
(12) Patent Application Publication
(10) Pub. No.: US 2014/0078062 A1
(43) Pub. Date: Mar. 20, 2014

(54) MOUSE DEVICE

(71) Applicant: PRIMAX ELECTRONICS LTD., Taipei (TW)

(72) Inventors: Yi-Guang Chen, Taipei (TW); Chun-Che Wu, Taipei (TW); Chun-Nan Su, Taipei (TW); Yi-Chieh Lin, Taipei (TW)

(73) Assignee: PRIMAX ELECTRONICS LTD., Taipei (TW)

(21) Appl. No.: 13/707,358

(22) Filed: Dec. 6, 2012

(30) Foreign Application Priority Data
Sep. 14, 2012 (TW) 101133739

(51) Int. Cl. G06F 3/02

(52) U.S. Cl. CPC G06F 3/0202
USPC 345/166

(57) ABSTRACT

A mouse device includes a lower cover, a circuit board, a first switch, a second switch, a first swinging element, and a second swinging element. The first swinging element includes a first pressing part and a second pressing part. The first swinging element and the second swinging element are located at a front side and a rear side of the lower cover, respectively. As the mouse device is swung in a leftward direction or a rightward direction, the front side and the rear side of the mouse device are simultaneously tilted. Moreover, since the first pressing part or the second pressing part of the first swinging element is pushed by a working surface where the mouse device is placed, the first pressing part or the second pressing part is moved toward the first switch or the second switch in order to trigger the first switch or the second switch.

### FIELD OF THE INVENTION

The present invention relates to a mouse device, and more particularly to a mouse device with a key switch, which is triggered by swinging the mouse device.

### BACKGROUND OF THE INVENTION

As known, most of the current mouse devices at least comprise the left button functions and the right button functions. FIG. 1 is a schematic perspective view illustrating the outward appearance of a conventional mouse device. As shown in FIG. 1, the conventional mouse device 10 comprises an upper cover 11 and two buttons 12 and 13. The buttons 12 and 13 are disposed on a top surface of the upper cover 11. By triggering the buttons 12 and 13, corresponding preset commands (e.g. a confirm command or a cancel command) are executed to implement corresponding functions. In a case that the user wants to implement the function corresponding to a preset command, the user's finger is firstly placed on the button 12 or the button 13. By pressing the button 12 or the button 13 with the use's finger, a key switch (not shown) corresponding to the button 12 or the button 13 is triggered.

For meeting the requirements of triggering the key switch, the upper cover should be frequently covered by the user's palm, and the user's fingers should be placed on corresponding buttons. Under this circumstance, the hand gesture of holding the mouse device by the user is restricted. Moreover, the frequent use of the mouse device may cause discomfort of the user's hand. Moreover, for designing the mouse device, the thickness of a button plate should be taken into consideration in order to provide the optimal tactile feel of touching the key switch. The thickness of the button plate may influence the outward appearance or the fabricating cost of the mouse device. For example, as for the elongated upper cover of the mouse device, the thin button plate can provide a better tactile feel. However, a dark image may be created on the periphery of the thin button plate. Conventionally, a spray painting process is then performed to improve the texture of the upper cover. The use of the spray painting process may increase the fabricating cost or adversely affect the outward appearance of the upper cover.

Therefore, there is a need of providing an improved mouse device in order to eliminate the above drawbacks.

### SUMMARY OF THE INVENTION

The present invention provides a mouse device with enhanced operating comfort.

The present invention provides a mouse device, in which the outward appearance of the mouse device is not influenced by the button mechanism.

In accordance with an aspect of the present invention, there is provided a mouse device. The mouse device includes an upper cover, a lower cover, a circuit board, a first switch, a second switch, a first swinging element, and a second swinging element. The lower cover includes a first perforation and a second perforation. The first perforation and the second perforation are located at a front side of the lower cover. The circuit board is arranged between the upper cover and the lower cover. The first switch and the second switch are disposed on a bottom surface of the circuit board. The first swinging element is arranged between the circuit board and the lower cover, and includes a first pressing part and a second pressing part. The first pressing part and the second pressing part are located at a first end and a second end of the first swinging element, respectively. The first pressing part is penetrated through the first perforation. The second pressing part is penetrated through the second perforation. The second swinging element is located at a rear side of the lower cover. When a first side of the upper cover is pressed, the first swinging element and the second swinging element are tilted along a first direction, and the first switch is triggered by the first pressing part. When a second side of the upper cover is pressed, the first swinging element and the second swinging element are tilted along a second direction, and the second switch is triggered by the second pressing part.

In an embodiment, the mouse device further includes a light source, an image capturing unit, a processor, and a touchpad. The image capturing unit is used for receiving a reflective light from the light source. The processor is electrically connected with the image capturing unit for calculating a displacement amount of the mouse device. The touchpad is disposed over the upper cover for sensing a change of a hand gesture.

In an embodiment, the mouse device further includes a first set of elastic elements and a second set of elastic elements. The first set of elastic elements are disposed over the first swinging element for returning the first swinging element to an original position thereof. The second set of elastic elements are disposed over the second swinging element for returning the second swinging element to an original position thereof.

In an embodiment, the first swinging element further includes a first intermediate part. The first intermediate part is fixed on the lower cover, so that the first swinging element is rotatable relative to the lower cover.

In an embodiment, the lower cover further includes a first recess, and the first swinging element further includes a first shaft. The first shaft is accommodated within the first recess, so that the first swinging element is rotated relative to the lower cover.

In an embodiment, the mouse device further includes a frame. The frame is disposed under the upper cover. Moreover, a second intermediate part of the second swinging element is fixed on the frame, so that the second swinging element is permitted to be swung relative to the lower cover.

In an embodiment, the mouse device further includes a frame. The second swinging element further includes a second shaft. The frame is disposed under the upper cover and includes a second recess. The second shaft is accommodated within the second recess, so that the second swinging element is permitted to be swung relative to the lower cover.

In an embodiment, the lower cover further comprises a third perforation. The third perforation is located at the rear side of the lower cover. The second swinging element is penetrated through the third perforation.

In an embodiment, the mouse device further includes plural foot pads. The plural foot pads are disposed under the first swinging element and the second swinging element for increasing a frictional force.

In an embodiment, the second swinging element is a foot pad, and the second swinging element is fixed on a bottom surface of the lower cover.

In accordance with another aspect of the present invention, there is provided a mouse device. The mouse device includes an upper cover, a lower cover, a circuit board, a first switch, a second switch, a swinging element, and a deformable element. The lower cover includes a first perforation and a second perforation. The first perforation and the second perforation are located at a front side of the lower cover. The circuit board is arranged between the upper cover and the lower cover. The first switch and the second switch are disposed on a bottom surface of the circuit board. The swinging element is arranged between the circuit board and the lower cover, and includes a first pressing part and a second pressing part. The first pressing part and the second pressing part are located at a first end and a second end of the swinging element, respectively. The first pressing part is penetrated through the first perforation. The second pressing part is penetrated through the second perforation. The deformable element is located at a rear side of the lower cover. When a first side of the upper cover is pressed, the swinging element and the deformable element are tilted along a first direction, and the first switch is triggered by the first pressing part. When a second side of the upper cover is pressed, the swinging element and the deformable element are tilted along a second direction, and the second switch is triggered by the second pressing part

In an embodiment, the mouse device further includes a light source, an image capturing unit, a processor, and a touchpad. The image capturing unit is used for receiving a reflective light from the light source. The processor is electrically connected with the image capturing unit for calculating a displacement amount of the mouse device. The touchpad is disposed over the upper cover for sensing a change of a hand gesture.

In an embodiment, the mouse device further includes an elastic element. The elastic element is disposed over the swinging element for returning the swinging element to an original position thereof.

In an embodiment, the swinging element further includes an intermediate part. The intermediate part is fixed on the lower cover, so that the swinging element is rotatable relative to the lower cover.

In an embodiment, the mouse device further includes plural foot pads. The plural foot pads are disposed under the swinging element for increasing a frictional force.

In an embodiment, the deformable element is a foot pad, and the deformable element is fixed on a bottom surface of the lower cover.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional mouse device;

FIG. 2 is a schematic functional block diagram illustrating a mouse device according to an embodiment of the present invention;

FIG. 3 is a schematic exploded view illustrating a mouse device according to a first embodiment of the present invention;

FIG. 4 schematically illustrates a first action of the first swinging element of the mouse device according to the first embodiment of the present invention;

FIG. 5 schematically illustrates a first action of the second swinging element of the mouse device according to the first embodiment of the present invention;

FIG. 6 schematically illustrates a second action of the first swinging element of the mouse device according to the first embodiment of the present invention;

FIG. 7 schematically illustrates a second action of the second swinging element of the mouse device according to the first embodiment of the present invention;

FIG. 8 is a schematic exploded view illustrating a mouse device according to a second embodiment of the present invention; and

FIG. 9 is a schematic exploded view illustrating a mouse device according to a third embodiment of the present invention.

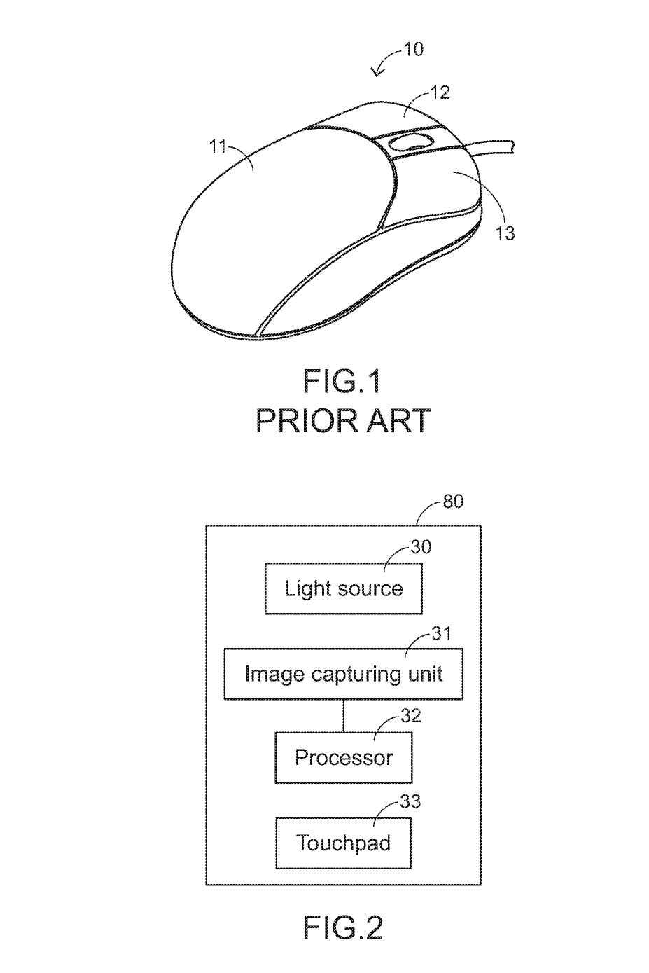

### DETAILED DESCRIPTION OF THE PREFERRED EMBODIMENT

The present invention provides a mouse device. The mouse device may be operated to control a cursor of a computer and allow the computer to implement a function corresponding to a specified command (e.g. a confirm command or a cancel command). In this context, the mouse device of the present invention is illustrated by referring to an optical touch mouse. It is noted that the mouse device is not limited to the optical touch mouse.

The displacement detection technology and the touch control technology used in the mouse device of the present invention are similar to those used in the conventional optical touch mouse.

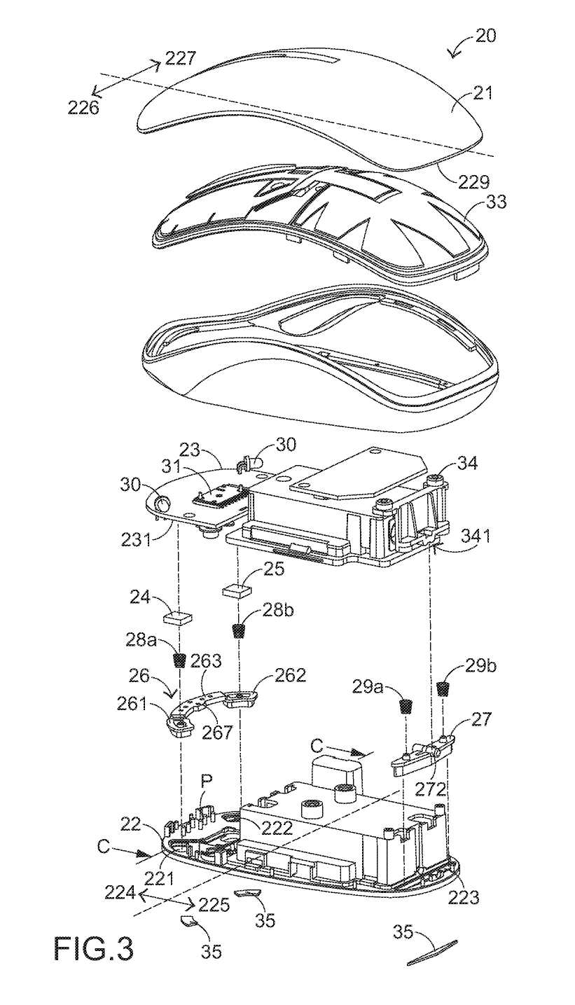

FIG. 2 is a schematic functional block diagram illustrating a mouse device according to an embodiment of the present invention. As shown in FIG. 2, the mouse device 80 comprises a light source 30, an image capturing unit 31, a processor 32, and a touchpad 33. The light source 30, the image capturing unit 31 and the processor 32 are disposed within the mouse device 80. The image capturing unit 31 is electrically connected with the processor 32. The touchpad 33 is disposed under an upper cover 21 of the mouse device 80 (see FIG. 3) for sensing a change of a hand gesture that is created by a user's finger. According to the change of the hand gesture, the mouse device 80 can provide diverse control operations.

After the mouse device 80 is placed on a working surface (e.g. a desk surface), the light beam emitted by the light source 30 is reflected as a reflective light by the working surface. After the reflective light is received by the image capturing unit 31, an electronic signal is generated by the image capturing unit 31 and transmitted to the processor 32. According to different electronic signals, different displacement amounts of the mouse device 80 are calculated by the processor 32. According to the displacement amounts of the mouse device 80, the processor 32 may control the direction and the distance of a cursor shown on a display screen of a computer. Consequently, the cursor of the computer can be correspondingly controlled. The operations and applications of the displacement detection technology and the touch control technology used in the mouse device of the present invention are similar to those used in the conventional optical touch mouse, and are not redundantly described herein.

FIG. 3 is a schematic exploded view illustrating a mouse device according to a first embodiment of the present invention. As shown in FIG. 3, the mouse device 20 comprises an upper cover 21, a lower cover 22, a circuit board 23, a first switch 24, a second switch 25, a first swinging element 26, a second swinging element 27, a first set of elastic elements 28a and 28b, a second set of elastic elements 29a and 29b, a frame 34, and plural foot pads 35.

The lower cover 22 comprises a first perforation 221, a second perforation 222, and a third perforation 223. The first perforation 221 and the second perforation 222 are located at a front side 224 of the lower cover 22. The third perforation 223 is located at a rear side 225 of the lower cover 22. In this embodiment, the front side 224 of the lower cover 22 is the side away from the user during the mouse device 20 is operated by the user. The rear side 225 of the lower cover 22 is the side close to the user during the mouse device 20 is operated by the user.

The circuit board 23 is arranged between the upper cover 21 and the lower cover 22. The first switch 24 and the second switch 25 are disposed on a bottom surface 231 of the circuit board 23. In addition, the first switch 24 is disposed over the first perforation 221 of the lower cover 22, and the second switch 25 is disposed over the second perforation 222 of the lower cover 22. The first switch 24 or the second switch 25 may be triggered to implement a function corresponding to a preset command (e.g. a confirm command or a cancel command) of the mouse device 20.

The first swinging element 26 is arranged between the circuit board 23 and the lower cover 22. In this embodiment, the first swinging element 26 comprises a first pressing part 261, a second pressing part 262, and a first intermediate part 263. The first pressing part 261 and the second pressing part 262 are located at a first end and a second end of the first swinging element 26, respectively. The first intermediate part 263 is arranged between the first pressing part 261 and the second pressing part 262. Moreover, the first pressing part 261 is penetrated through the first perforation 221. The second pressing part 262 is penetrated through the second perforation 222. The first intermediate part 263 of the first swinging element 26 is fixed on a top surface of the lower cover 22, so that the first swinging element 26 may be swung relative to the lower cover 22.

In this embodiment, the first swinging element 26 comprises plural fixing holes 267. The lower cover 22 comprises plural fixing posts P. The plural fixing posts P are fixed on the top surface of the lower cover 22, and penetrated through the plural fixing holes 267 of the first swinging element 26. Consequently, the first swinging element 26 is fixed on the lower cover 22. Alternatively, in some other embodiments, the first swinging element 26 may be fixed on the lower cover 22 by an adhering means, an engaging means, a screwing means or any other fixing means. The means of fixing the first swinging element 26 on the lower cover 22 is presented herein for purpose of illustration and description only.

The second swinging element 27 comprises a second shaft 272. The frame 34 comprises a second recess 341. The second swinging element 27 is penetrated through the third perforation 223 of the lower cover 22, and located at the rear side 225 of the lower cover 22. In this embodiment, the front side 224 of the lower cover 22 is the side away from the user during the mouse device 20 is operated by the user. The rear side 225 of the lower cover 22 is the side close to the user during the mouse device 20 is operated by the user.

As shown in FIG. 3, the first swinging element 26 and the second swinging element 27 are located at the front side 224 and the rear side 225 of the lower cover 22, respectively. As the mouse device 20 is swung by the user, the second swinging element 27 may assist in swinging the mouse device 20. Consequently, a front side and a rear side of the mouse device 20 are simultaneously tilted. Since the rear side of the mouse device 20 is no longer static, the mouse device 20 can be swung more easily. Moreover, for swinging the mouse device 20 more effortlessly, the length of the swinging element that is closer to the user should be shorter. In other words, the length of the second swinging element 27 is shorter than the length of the first swinging element 26, but is not limited thereto.

The frame 34 is disposed under the upper cover 21. A first end of the frame 34 is connected with a bottom surface 229 of the upper cover 21. The second recess 341 is located at a second end of the frame 34. The second shaft 272 of the second swinging element 27 is accommodated within the second recess 341 of the frame 34, so that the second swinging element 27 may be swung relative to the lower cover 22.

The first set of elastic elements 28a and 28b are disposed over the first swinging element 26. The second set of elastic elements 29a and 29b are disposed over the second swinging element 27. Due to the first set of elastic elements 28a and 28b and the second set of elastic elements 29a and 29b, after the first swinging element 26 and the second swinging element 27 are pressed, the first swinging element 26 and the second swinging element 27 can be automatically returned to their original positions. The two ends of the elastic element 28a are sustained against the first pressing part 261 and the first switch 24, respectively. The two ends of the elastic element 28b are sustained against the second pressing part 262 and the second switch 25, respectively. The two ends of the elastic element 29a are sustained against a first end of the second swinging element 27 and the frame 34, respectively. The two ends of the elastic element 29b are sustained against a second end of the second swinging element 27 and the frame 34, respectively. In this embodiment, the first set of elastic elements 28a and 28b and the second set of elastic elements 29a and 29b are springs, but are not limited thereto.

The plural foot pads 35 are disposed under the first swinging element 26 and the second swinging element 27. The uses of the foot pads 35 can increase the frictional force between the mouse device 20 and the working surface where the mouse device 20 is placed. The plural foot pads 35 may be made of rubber, silicone or any other material with a higher friction coefficient and a compressive deformation property. In addition to the increase of the friction force of the mouse device 20, the plural foot pads 35 have cushioning and shock-absorbing functions in order to provide the comfort of using the mouse device 20.

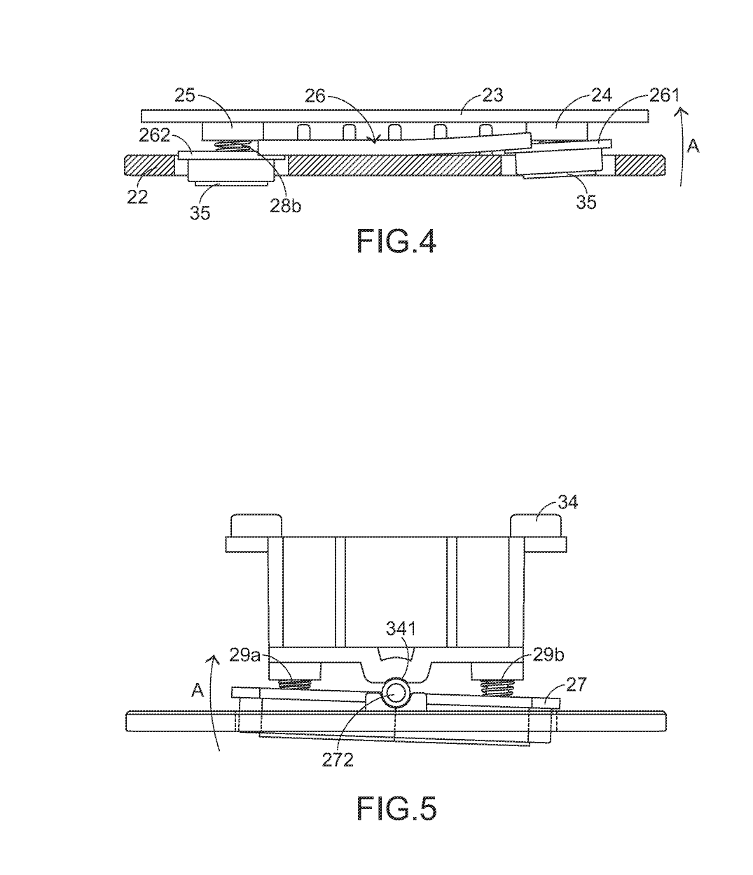

FIG. 4 schematically illustrates a first action of the first swinging element of the mouse device according to the first embodiment of the present invention. FIG. 5 schematically illustrates a first action of the second swinging element of the mouse device according to the first embodiment of the present invention. Hereinafter, the first actions of the first swinging element 26 and the second swinging element 27 will be illustrated with reference to FIGS. 3, 4 and 5. Firstly, as shown in FIG. 3, the mouse device 20 is swung such that a first side 226 of the upper cover 21 is pressed. Consequently, the first swinging element 26 and the second swinging element 27 are tilted along a first direction A. Under this circumstance, the elastic element 28a and the elastic element 29a are compressed to generate elastic potential energy.

Then, as shown in FIG. 4, the first pressing part 261 is pushed by the working surface where the mouse device 20 is placed. Consequently, the first pressing part 261 is moved toward the first switch 24. Under this circumstance, the first switch 24 is pressed and triggered by the first pressing part 261. As shown in FIG. 5, the second swinging element 27 is pushed by the working surface where the mouse device 20 is placed. Consequently, the second swinging element 27 is rotated in the first direction A. In other words, since the front side and the rear side of the mouse device 20 are simultaneously tilted, the rear side of the mouse device 20 is no longer static and the mouse device 20 can be swung more easily.

Please refer to FIG. 3 again. In a case that the first side 226 of the upper cover 21 is no longer pressed, the elastic potential energy stored in the elastic element 28a and the elastic element 29a will be released. Consequently, the first swinging element 26 and the second swinging element 27 are returned to their original positions.

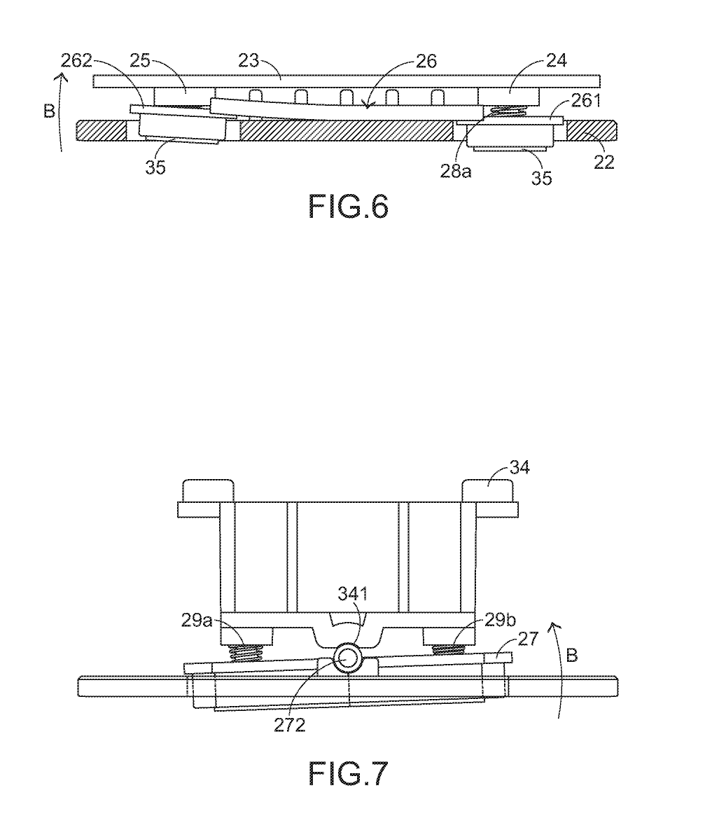

FIG. 6 schematically illustrates a second action of the first swinging element of the mouse device according to the first embodiment of the present invention. FIG. 7 schematically illustrates a second action of the second swinging element of the mouse device according to the first embodiment of the present invention. Hereinafter, the second actions of the first swinging element 26 and the second swinging element 27 will be illustrated with reference to FIGS. 3, 6 and 7. Firstly, as shown in FIG. 3, the mouse device 20 is swung such that a second side 227 of the upper cover 21 is pressed. Consequently, the first swinging element 26 and the second swinging element 27 are tilted along a second direction B. Under this circumstance, the elastic element 28b and the elastic element 29b are compressed to generate elastic potential energy.

Then, as shown in FIG. 6, the second pressing part 262 is pushed by the working surface where the mouse device 20 is placed. Consequently, the second pressing part 262 is moved toward the second switch 25. Under this circumstance, the second switch 25 is pressed and triggered by the second pressing part 262. As shown in FIG. 7, the second swinging element 27 is pushed by the working surface where the mouse device 20 is placed. Consequently, the second swinging element 27 is rotated in the second direction B. In other words, since the front side and the rear side of the mouse device 20 are simultaneously tilted, the rear side of the mouse device 20 is no longer static and the mouse device 20 can be swung more easily.

In a case that the second side 227 of the upper cover 21 is no longer pressed, the elastic potential energy stored in the elastic element 28b and the elastic element 29b will be released. Consequently, the first swinging element 26 and the second swinging element 27 are returned to their original positions.

It is noted that the way for swinging the mouse device of the present invention may be implemented by many well-known mechanisms. The structures of the first swinging element and the second swinging element in some other embodiments will be illustrated as follows, but are not limited thereto.

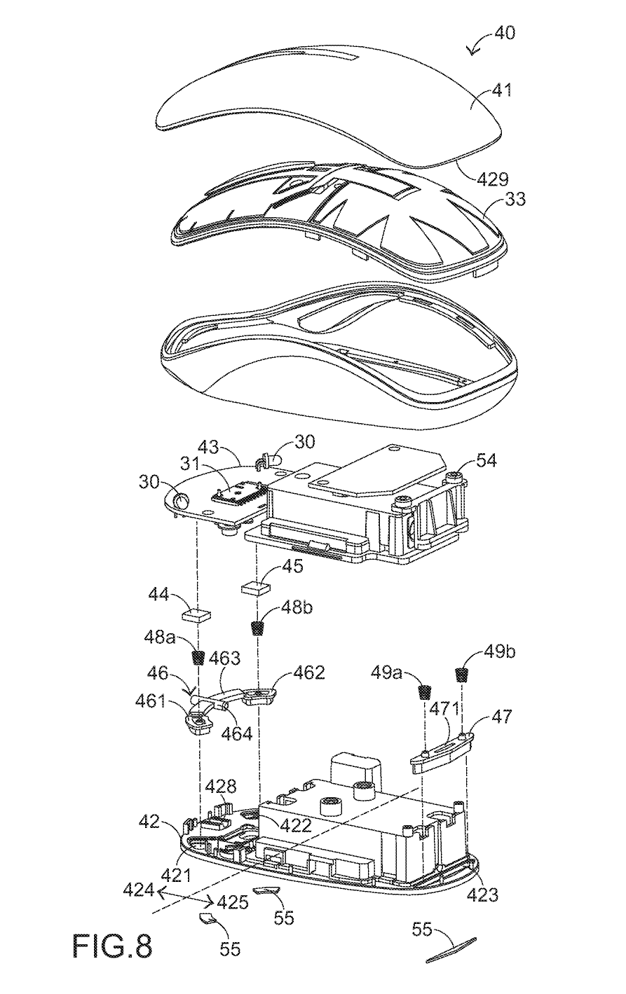

FIG. 8 is a schematic exploded view illustrating a mouse device according to a second embodiment of the present invention. As shown in FIG. 8, the mouse device 40 comprises an upper cover 41, a lower cover 42, a circuit board 43, a first switch 44, a second switch 45, a first swinging element 46, a second swinging element 47, a first set of elastic elements 48a and 48b, a second set of elastic elements 49a and 49b, a frame 54, and plural foot pads 55.

In comparison with the first embodiment, the first swinging element 46, the second swinging element 47 and the structures of the lower cover 42 corresponding to the first swinging element 46 and the second swinging element 47 are distinguished. The other components of the mouse device 40 of the second embodiment are similar to those of the first embodiment, and are not redundantly described herein. The mouse device 40 of the second embodiment (see FIG. 8) and the mouse device 20 of the first embodiment (see FIG. 3) will be illustrated as follows.

The lower cover 42 comprises a first perforation 421, a second perforation 422, a third perforation 423, and a first recess 428. The first perforation 421 and the second perforation 422 are located at a front side 424 of the lower cover 42. The third perforation 423 is located at a rear side 425 of the lower cover 42. In this embodiment, the front side 424 of the lower cover 42 is the side away from the user during the mouse device 40 is operated by the user. The rear side 425 of the lower cover 42 is the side close to the user during the mouse device 40 is operated by the user.

In this embodiment, the first swinging element 46 comprises a first pressing part 461, a second pressing part 462, a first intermediate part 463, and a first shaft 464. The first pressing part 461 and the second pressing part 462 are located at a first end and a second end of the first swinging element 46, respectively. The first intermediate part 463 is arranged between the first pressing part 461 and the second pressing part 462. Moreover, the first shaft 464 is located at the first intermediate part 463 of the first swinging element 46.

The first pressing part 461 is penetrated through the first perforation 421. The second pressing part 462 is penetrated through the second perforation 422. The first shaft 464 is accommodated within the first recess 428 of the lower cover 42, so that the first swinging element 46 is rotated relative to the lower cover 42.

The second swinging element 47 is penetrated through the third perforation 423 of the lower cover 42, and located at the rear side 425 of the lower cover 42. The second swinging element 47 comprises a second intermediate part 471. The second intermediate part 471 is arranged between the two ends of the second swinging element 47. In this embodiment, the front side 424 of the lower cover 42 is the side away from the user during the mouse device 40 is operated by the user. The rear side 425 of the lower cover 42 is the side close to the user during the mouse device 40 is operated by the user.

The frame 54 is disposed under the upper cover 41. A first end of the frame 54 is connected with a bottom surface 429 of the upper cover 41. The second intermediate part 471 of the second swinging element 47 is fixed on a second end of the frame 54, so that the second swinging element 47 may be swung relative to the lower cover 42.

In this embodiment, the second swinging element 47 is securely fixed on the frame 54 via an adhesive, but is not limited thereto.

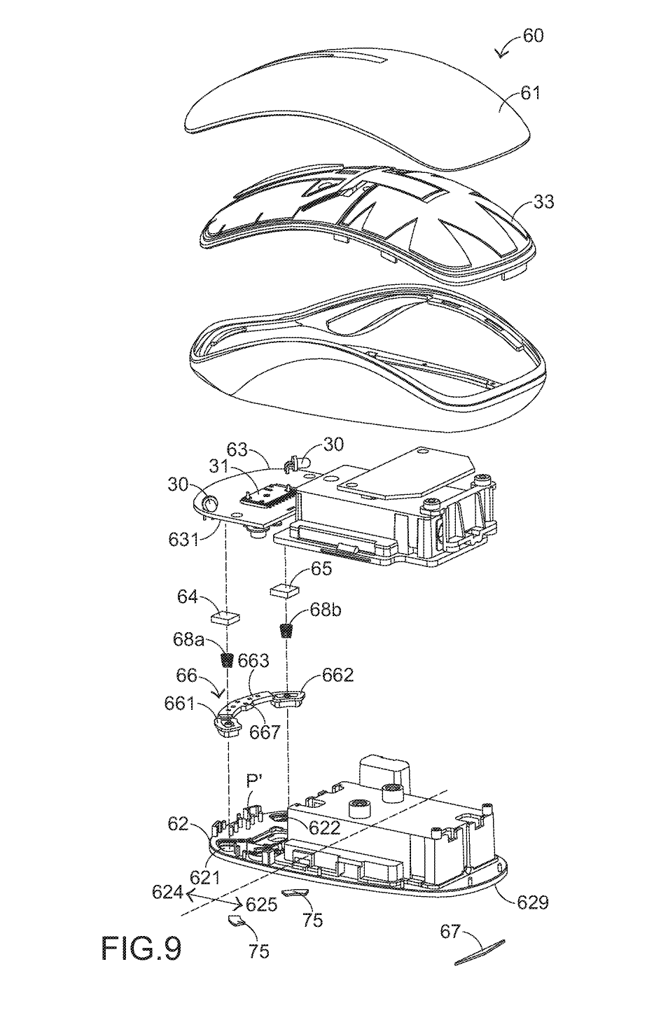

FIG. 9 is a schematic exploded view illustrating a mouse device according to a third embodiment of the present invention. As shown in FIG. 9, the mouse device 60 comprises an upper cover 61, a lower cover 62, a circuit board 63, a first switch 64, a second switch 65, a swinging element 66, a deformable element 67, two elastic elements 68a and 68b, and plural foot pads 75.

Except for the following items, the configurations of the mouse device 60 of the third embodiment (see FIG. 9) are substantially identical to those of the mouse device 20 of the first embodiment (see FIG. 3).

The lower cover 62 comprises a first perforation 621 and a second perforation 622. The first perforation 621 and the second perforation 622 are located at a front side 624 of the lower cover 62. In this embodiment, the front side 624 of the lower cover 62 is the side away from the user during the mouse device 60 is operated by the user.

The circuit board 63 is arranged between the upper cover 61 and the lower cover 62. The first switch 64 and the second switch 65 are disposed on a bottom surface 631 of the circuit board 63. In addition, the first switch 64 is disposed over the first perforation 621 of the lower cover 62, and the second switch 65 is disposed over the second perforation 622 of the lower cover 62. The first switch 64 or the second switch 65 may be triggered to implement a function corresponding to a preset command (e.g. a confirm command or a cancel command) of the mouse device 60.

The swinging element 66 is arranged between the circuit board 63 and the lower cover 62. In this embodiment, the swinging element 66 comprises a first pressing part 661, a second pressing part 662, and an intermediate part 663. The first pressing part 661 and the second pressing part 662 are located at a first end and a second end of the swinging element 66, respectively. The intermediate part 663 is arranged between the first pressing part 661 and the second pressing part 662. Moreover, the first pressing part 661 is penetrated through the first perforation 621, and the second pressing part 662 is penetrated through the second perforation 622. The intermediate part 663 of the swinging element 66 is fixed on a top surface of the lower cover 62, so that the swinging element 66 may be swung relative to the lower cover 62.

In this embodiment, the swinging element 66 comprises plural fixing holes 667. The lower cover 62 comprises plural fixing posts P′. The plural fixing posts P′ are fixed on the top surface of the lower cover 62, and penetrated through the plural fixing holes 667 of the swinging element 66. Consequently, the swinging element 66 is fixed on the lower cover 62. Alternatively, in some other embodiments, the swinging element 66 may be fixed on the lower cover 62 by an adhering means, an engaging means, a screwing means or any other fixing means. The means of fixing the swinging element 66 on the lower cover 62 is presented herein for purpose of illustration and description only.

The deformable element 67 is located at a rear side 625 of the lower cover 62. In this embodiment, the deformable element 67 is a foot pad such as a flexible rubbery block. In this embodiment, the rear side 625 of the lower cover 62 is the side close to the user during the mouse device 60 is operated by the user.

As shown in FIG. 9, the swinging element 66 and the deformable element 67 are located at the front side 624 and the rear side 625 of the lower cover 62, respectively. As the mouse device 60 is swung by the user, the deformable element 67 may be subjected to deformation in order to assist in swinging the mouse device 60. Consequently, the front side and the rear side of the mouse device 60 are simultaneously tilted. Since the rear side 625 of the mouse device 60 is no longer static, the mouse device 60 can be swung more easily. Moreover, for swinging the mouse device 60 more effortlessly, the length of the deformable element 67 that is closer to the user should be shorter. In other words, the length of the deformable element 67 is shorter than the length of the swinging element 66, but is not limited thereto.

The elastic elements 68a and 68b are disposed over the swinging element 66. Due to the elastic elements 68a and 68b, after the swinging element 66 is pressed, the swinging element 66 can be automatically returned to the original position. The two ends of the elastic element 68a are sustained against the first pressing part 661 and the first switch 64, respectively. The two ends of the elastic element 68b are sustained against the second pressing part 662 and the second switch 65, respectively. In this embodiment, the elastic elements 68a and 68b are springs, but are not limited thereto.

The plural foot pads 75 are disposed under the swinging element 66. The uses of the foot pads 75 can increase the frictional force between the mouse device 60 and the working surface where the mouse device 60 is placed. Preferably, the plural foot pads 75 may be made of rubber, silicone or any other material with a higher friction coefficient and a compressive deformation property. In addition to the increase of the friction force of the mouse device 60, the plural foot pads 75 have cushioning and shock-absorbing functions in order to provide the comfort of using the mouse device 60.

The operations of the mouse device 60 of the third embodiment are substantially identical to those of the mouse device 20 of the first embodiment as shown in FIG. 3. On the other hand, the second swinging element 27 of the mouse device 20 of the first embodiment is replaced by the deformable element 67 of the mouse device 60 of the third embodiment. Moreover, the deformable element 67 is located at the rear side 625 of the lower cover 62, and fixed on a bottom surface 629 of the lower cover 62. In contrast, the second swinging element 27 in the mouse device 20 of the first embodiment as shown in FIG. 3 is penetrated through the third perforation 223.

From the above descriptions, the present invention provides a mouse device. A first swinging element is disposed on a lower cover of the mouse device. As the mouse device is swung, the first swinging element is pushed by a working surface where the mouse device is placed. Consequently, any pressing part of the first swinging element is moved toward a corresponding switch so as to press and trigger the switch. Moreover, the first swinging element and a second swinging element are located at a front side and a rear side of the lower cover, respectively. As the mouse device is swung, a front side and a rear side of the mouse device are simultaneously tilted. In other words, the switch of the mouse device can be triggered by a swinging action without the need of changing the outward appearance of the mouse device or the thickness of the button plate. Consequently, during the mouse device is operated by the user, the discomfort of the user's finger will be minimized. Moreover, since the front side and the rear side of the mouse device are simultaneously tilted, the mouse device can be swung more easily. Consequently, the mouse device of the present invention can be operated in an effortless and comfortable manner.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse device, comprising:
an upper cover;
a lower cover comprising a first perforation and a second perforation, wherein said first perforation and said second perforation are located at a front side of said lower cover;
a circuit board arranged between said upper cover and said lower cover;
a first switch and a second switch disposed on a bottom surface of said circuit board;
a first swinging element arranged between said circuit board and said lower cover, and comprising a first pressing part and a second pressing part, wherein said first pressing part and said second pressing part are located at a first end and a second end of said first swinging element, respectively, wherein said first pressing part is penetrated through said first perforation, and said second pressing part is penetrated through said second perforation; and
a second swinging element located at a rear side of said lower cover,
wherein when a first side of said upper cover is pressed, said first swinging element and said second swinging element are tilted along a first direction, and said first switch is triggered by said first pressing part, wherein when a second side of said upper cover is pressed, said first swinging element and said second swinging element are tilted along a second direction, and said second switch is triggered by said second pressing part.

2. The mouse device according to claim 1, further comprising:
a light source;
an image capturing unit for receiving a reflective light from said light source;
a processor electrically connected with said image capturing unit for calculating a displacement amount of said mouse device; and
a touchpad disposed over said upper cover for sensing a change of a hand gesture.

3. The mouse device according to claim 1, further comprising:
a first set of elastic elements disposed over said first swinging element for returning said first swinging element to an original position thereof; and
a second set of elastic elements disposed over said second swinging element for returning said second swinging element to an original position thereof.

4. The mouse device according to claim 1, wherein said first swinging element further comprises a first intermediate part, wherein said first intermediate part is fixed on said lower cover, so that said first swinging element is rotatable relative to said lower cover.

5. The mouse device according to claim 1, wherein said lower cover further comprise a first recess, and said first swinging element further comprises a first shaft, wherein said first shaft is accommodated within said first recess, so that said first swinging element is rotated relative to said lower cover.

6. The mouse device according to claim 1, wherein said mouse device further comprises a frame, said frame is disposed under said upper cover, and a second intermediate part of said second swinging element is fixed on said frame, so that said second swinging element is permitted to be swung relative to said lower cover.

7. The mouse device according to claim 1, wherein said mouse device further comprises a frame, and said second swinging element further comprises a second shaft, wherein said frame is disposed under said upper cover and comprises a second recess, wherein said second shaft is accommodated within said second recess, so that said second swinging element is permitted to be swung relative to said lower cover.

8. The mouse device according to claim 1, wherein said lower cover further comprises a third perforation, wherein said third perforation is located at said rear side of said lower cover, and said second swinging element is penetrated through said third perforation.

9. The mouse device according to claim 1, further comprising plural foot pads, wherein said plural foot pads are disposed under said first swinging element and said second swinging element for increasing a frictional force.

10. The mouse device according to claim 1, wherein said second swinging element is a foot pad, and said second swinging element is fixed on a bottom surface of said lower cover.

11. A mouse device, comprising:
an upper cover;
a lower cover comprising a first perforation and a second perforation, wherein said first perforation and said second perforation are located at a front side of said lower cover;
a circuit board arranged between said upper cover and said lower cover;
a first switch and a second switch disposed on a bottom surface of said circuit board;
a swinging element arranged between said circuit board and said lower cover, and comprising a first pressing part and a second pressing part, wherein said first pressing part and said second pressing part are located at a first end and a second end of said swinging element, respectively, wherein said first pressing part is penetrated through said first perforation, and said second pressing part is penetrated through said second perforation; and
a deformable element located at a rear side of said lower cover,
wherein when a first side of said upper cover is pressed, said swinging element and said deformable element are tilted along a first direction, and said first switch is triggered by said first pressing part, wherein when a second side of said upper cover is pressed, said swinging element and said deformable element are tilted along a second direction, and said second switch is triggered by said second pressing part

12. The mouse device according to claim 11, further comprising:
a light source;
an image capturing unit for receiving a reflective light from said light source;
a processor electrically connected with said image capturing unit for calculating a displacement amount of said mouse device; and
a touchpad disposed over said upper cover for sensing a change of a hand gesture.

13. The mouse device according to claim 11, further comprising an elastic element, wherein said elastic element is disposed over said swinging element for returning said swinging element to an original position thereof.

14. The mouse device according to claim 11, wherein said swinging element further comprises an intermediate part, wherein said intermediate part is fixed on said lower cover, so that said swinging element is rotatable relative to said lower cover.

15. The mouse device according to claim 11, further comprising plural foot pads, wherein said plural foot pads are disposed under said swinging element for increasing a frictional force.

16. The mouse device according to claim 11, wherein said deformable element is a foot pad, and said deformable element is fixed on a bottom surface of said lower cover.
